(19) United States
(12) Patent Application Publication
(10) Pub. No.: US 2026/0360780 A1
(43) Pub. Date: Nov. 12, 2026

(54) FUEL CELL SYSTEM AND WORK MACHINE

(71) Applicant: KOMATSU LTD., Tokyo (JP)

(72) Inventor: Yuki ONO, Tokyo (JP)

(21) Appl. No.: 19/130,723

(22) PCT Filed: Dec. 22, 2023
(86) PCT No.: PCT/JP2023/046184

§ 371 Date: May 16, 2025

(30) Foreign Application Priority Data
Dec. 22, 2022 (JP) 2022-205772

(51) Int. Cl. H01M 8/04111; H01M 8/04082; H01M 8/249

(52) U.S. Cl. CPC H01M 8/04111; H01M 8/04201; H01M 8/249; H01M 2250/20

(57) ABSTRACT

A fuel cell system includes a plurality of fuel cells that generate electric energy by reacting hydrogen gas with oxygen in air, a plurality of individual air compressors provided respectively in the plurality of fuel cells, and a common air compressor. Each of the individual air compressors boosts air to a desired operation pressure and supplies the air to a corresponding one of the fuel cells. The common air compressor is provided on an upstream side of the plurality of individual air compressors. The common air compressor boosts air and supplies air having a predetermined reference pressure to the plurality of individual air compressors.

### CROSS-REFERENCE TO RELATED APPLICATIONS

This application is a U.S. National stage application of International Application No. PCT/JP2023/046184, filed on Dec. 22, 2023. This U.S. National stage application claims priority under 35 U.S.C. § 119(a) to Japanese Patent Application No. 2022-205772, filed in Japan on Dec. 22, 2022, the entire contents of which are hereby incorporated herein by reference.

### BACKGROUND

### Technical Field

The present disclosure relates to a fuel cell system and a work machine.

A fuel cell generates electric energy by a chemical reaction between hydrogen and oxygen. Hydrogen as fuel is continuously supplied from a high-pressure tank filled with hydrogen gas. On the other hand, oxygen is usually taken out from the atmosphere. Therefore, the fuel cell is provided with an air compressor for compressing air and supplying the compressed air to the fuel cell. JP 2017-152230 A discloses an air compressor that supplies compressed air to a fuel cell.

### SUMMARY

Incidentally, a work machine including a fuel cell system may be used in a high altitude environment with low atmospheric pressure. Since the air compressor compresses air to a pressure required by the fuel cell, the lower the external air pressure, the larger the power required by the air compressor. Therefore, when a fuel cell is used in a high altitude environment, it takes time to generate air having a pressure necessary for outputting desired electric power, and responsiveness may be lowered.

An object of the present disclosure is to provide a fuel cell system and a work machine capable of preventing a change in responsiveness due to external atmospheric pressure.

According to an aspect of the present disclosure, a fuel cell system includes: a plurality of fuel cells that generate electric energy by reacting hydrogen gas with oxygen in air; a plurality of individual air compressors provided respectively in the plurality of fuel cells, each of the individual air compressors boosting air to a predetermined operation pressure and supplying the air to a corresponding one of the fuel cells; and a common air compressor provided on a primary side of the plurality of individual air compressors, the common air compressor boosting air and supplying the air to the plurality of individual air compressors.

According to the above aspect, a fuel cell system can prevent a change in responsiveness due to external atmospheric pressure.

### BRIEF DESCRIPTION OF DRAWINGS

FIG. 1 is a perspective view schematically illustrating a transportation vehicle according to a first embodiment.

FIG. 2 is a schematic block diagram illustrating a configuration of a power system and a drive system of the transportation vehicle according to the first embodiment.

FIG. 3 is a schematic block diagram illustrating a configuration of a fuel cell system according to the first embodiment.

FIG. 4 is a schematic block diagram illustrating a configuration of a fuel cell system according to a second embodiment.

### DETAILED DESCRIPTION OF EMBODIMENT(S)

### First Embodiment

### Configuration of Transportation Vehicle

Hereinafter, embodiments will be described in detail with reference to the drawings.

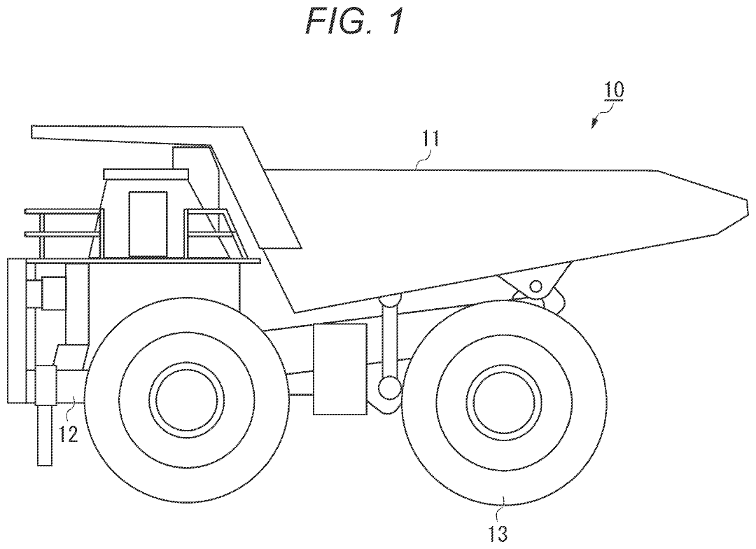

FIG. 1 is a perspective view schematically illustrating a transportation vehicle 10 according to a first embodiment. The transportation vehicle 10 is a dump truck that travels in a work site such as a mine to transport loads. The transportation vehicle 10 may be an unmanned dump truck that operates in an unmanned manner without depending on a driving operation by a driver, or may be a manned dump truck that operates on the basis of a driving operation by a driver.

The transportation vehicle 10 includes a dump body 11, a vehicle body 12, and a traveling device 13.

The dump body 11 is a member on which a load is loaded. At least a part of the dump body 11 is disposed above the vehicle body 12. The dump body 11 performs a dumping operation and a lowering operation. The dump body 11 is adjusted to the dumping posture and the loading posture by the dumping operation and the lowering operation. The dumping posture refers to a posture in which the dump body 11 is raised. The loading posture refers to a posture in which the dump body 11 is lowered.

The dumping operation refers to an operation of separating the dump body 11 from the vehicle body 12 and inclining the dump body 11 in a dumping direction. The dumping direction is the rear side of the vehicle body 12. In the embodiment, the dumping operation includes raising the front end portion of the dump body 11 and inclining the dump body 11 backward. By the dumping operation, the loading surface of the dump body 11 is inclined downward and backward.

The lowering operation refers to an operation of bringing the dump body 11 close to the vehicle body 12. In the embodiment, the lowering operation includes lowering the front end portion of the dump body 11.

When the soil discharging work is to be performed, a dumping operation is performed to change the posture of the dump body 11 from the loading posture to the dumping posture. In a case where a load is loaded on the dump body 11, the load is discharged backward from the rear end portion of the dump body 11 by the dumping operation. When the loading work is to be performed, the dump body 11 is adjusted to the loading posture.

The vehicle body 12 includes a vehicle body frame. The vehicle body 12 supports the dump body 11. The vehicle body 12 is supported by the traveling device 13.

The traveling device 13 supports the vehicle body 12. The traveling device 13 causes the transportation vehicle 10 to travel. The traveling device 13 moves the transportation vehicle 10 forward or backward. At least a part of the traveling device 13 is disposed below the vehicle body 12. The traveling device 13 includes a pair of front wheels and a pair of rear wheels. The front wheel is a steering wheel, and the rear wheel is a driving wheel.

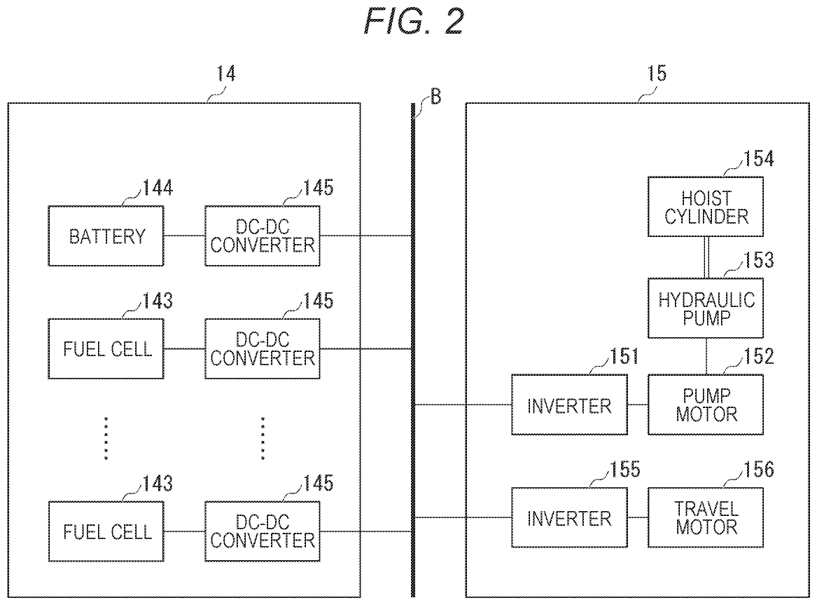

FIG. 2 is a schematic block diagram illustrating a configuration of a power system 14 and a drive system 15 of the transportation vehicle 10 according to the first embodiment. The transportation vehicle 10 includes the power system 14 and the drive system 15. The power system 14 generates power for operating the drive system 15 by reacting hydrogen with oxygen. The drive system 15 operates to drive the dump body 11 and the traveling device 13. The dump body 11 is an example of a work unit driven by electric energy generated by a fuel cell.

The power system 14 includes a fuel cell 143, a battery 144, and DC-DC converters 145. The power system 14 includes a plurality of fuel cells 143.

The fuel cells 143 each generate electric power by electrochemical reaction between hydrogen and oxygen. The battery 144 stores electric power generated in the fuel cells 143. The DC-DC converters 145 are provided corresponding to the fuel cells 143 and the battery 144. The DC-DC converter 145 outputs power from the corresponding fuel cell 143 or battery 144 in accordance with an instruction from the control device.

The power output from the power system 14 is output to the drive system 15 via a bus B. The drive system 15 includes an inverter 151, a pump drive motor 152, a hydraulic pump 153, a hoist cylinder 154, an inverter 155, and a travel drive motor 156. The inverter 151 converts the direct current from the bus B into a three-phase alternating current and supplies the three-phase alternating current to the pump drive motor 152. The pump drive motor 152 drives the hydraulic pump 153. The hydraulic oil discharged from the hydraulic pump 153 is supplied to the hoist cylinder 154 via a control valve (not illustrated). When the hydraulic oil is supplied to the hoist cylinder 154, the hoist cylinder 154 is operated. The hoist cylinder 154 causes the dump body 11 to perform a dumping operation or a lowering operation. The inverter 155 converts the direct current from the bus B into a three-phase alternating current and supplies the three-phase alternating current to the travel drive motor 156. The rotational force generated by the travel drive motor 156 is transmitted to the rear wheels of the traveling device 13.

### Configuration of Fuel Cell System

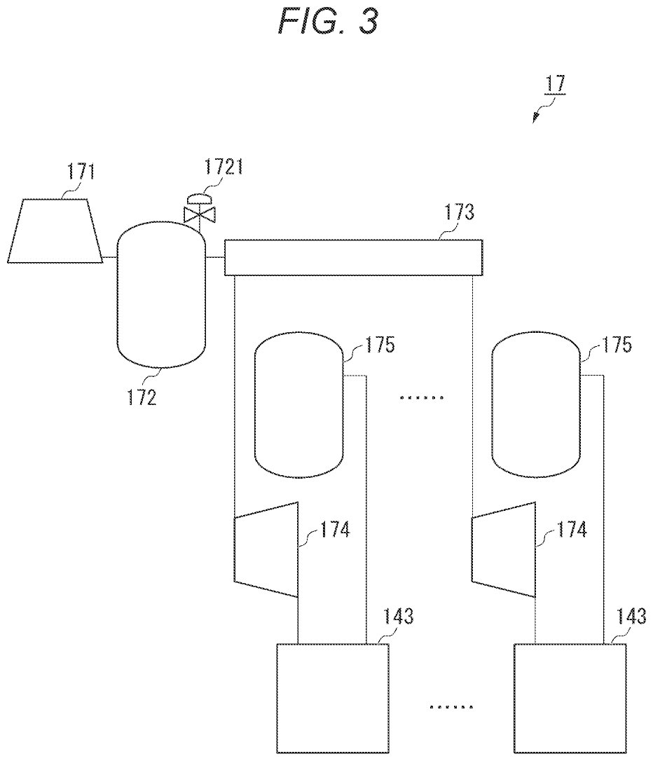

FIG. 3 is a schematic block diagram illustrating a configuration of a fuel cell system 17 according to the first embodiment. The transportation vehicle 10 includes the fuel cell system 17 that supplies hydrogen and air to the plurality of fuel cells 143. The fuel cell system 17 includes a common air compressor 171, an air tank 172, an intake manifold 173, an individual air compressor 174, a hydrogen tank 175, and the fuel cells 143.

The common air compressor 171 compresses the atmosphere and boosts the pressure to a predetermined reference pressure (for example, 0.1 MPa).

The air tank 172 stores the compressed air supplied from the common air compressor 171. An intake port of the air tank 172 is connected to a discharge port of the common air compressor 171. A pressure adjustment valve 1721 is provided at a discharge port of the air tank 172. The pressure adjustment valve 1721 adjusts the pressure of the air supplied from the discharge port of the air tank 172 to a reference pressure.

The intake manifold 173 includes one intake port and a plurality of discharge ports, and distributes air supplied to the intake port to the plurality of discharge ports. The number of discharge ports of the intake manifold 173 is equal to the number of fuel cells 143. An intake port of the intake manifold 173 is connected to the discharge port of the air tank 172.

The plurality of individual air compressors 174 are provided corresponding to the fuel cells 143, respectively. The individual air compressors 174 each compress the air and boost the air to an operation pressure instructed by the control device. The intake port of each of the individual air compressors 174 is connected to a corresponding discharge port of the intake manifold 173. The discharge port of each of the individual air compressors 174 is connected to the intake port on the positive electrode side of the fuel cells 143.

The plurality of hydrogen tanks 175 are tanks for storing compressed hydrogen. Hydrogen is supplied from the hydrogen tanks 175 to the fuel cells 143.

That is, in the fuel cell system 17, the common air compressor 171, the air tank 172, the intake manifold 173, the individual air compressors 174, and the fuel cells 143 are provided in order from the upstream side in the path through which the air flows.

### Operation and Effect

As described above, the fuel cell system 17 includes the common air compressor 171 that boosts the atmospheric pressure to the reference pressure, in the upstream of the plurality of individual air compressors 174. As a result, regardless of the level of the atmospheric pressure in the environment of the transportation vehicle 10, the plurality of individual air compressors 174 can constantly increase the pressure from the reference pressure to the operation pressure.

For example, in a case where the fuel cell system 17 does not include the common air compressor 171, when the external pressure is 0.07 MPa and the operation pressure instructed by the control device is 0.25 MPa, each of the plurality of individual air compressors 174 needs to increase the pressure by 0.18 MPa. On the other hand, when the fuel cell system 17 includes the common air compressor 171 as in the first embodiment, it is sufficient that each of the plurality of individual air compressors 174 increases the pressure by 0.15 MPa. That is, the fuel cell system 17 according to the first embodiment can quickly increase the pressure of the air to the operation pressure instructed by the control device. Accordingly, the fuel cell system 17 according to the first embodiment can prevent a decrease in efficiency of the power system 14. The fuel cell system 17 according to the first embodiment can prevent the supplied air amount from becoming insufficient with respect to the required air amount and prevent deterioration of the fuel cell by rapid pressure increase.

When the common air compressor 171 is not provided, it is necessary for each individual air compressor 174 to compensate for the decrease in the external air pressure. However, according to the first embodiment, since the common air compressor 171 compensates for the decrease in the external air pressure, an increase in power consumption can be suppressed.

The fuel cell system 17 according to the first embodiment includes the air tank 172 that stores the air boosted to the reference pressure by the common air compressor 171. The air tank 172 can suppress the fluctuation of the pressure of the air supplied to the individual air compressor 174, and can reduce the risk of shortage of the air due to the consumption of the air by the individual air compressor 174. This makes it possible to prevent inching of the common air compressor 171 from occurring when the consumption of air by the individual air compressor 174 increases. The fuel cell system 17 according to another embodiment may not necessarily include the air tank 172. Even in a case where the fuel cell system 17 does not include the air tank 172, it is possible to suppress a change in responsiveness due to the external pressure by including the common air compressor 171.

### Second Embodiment

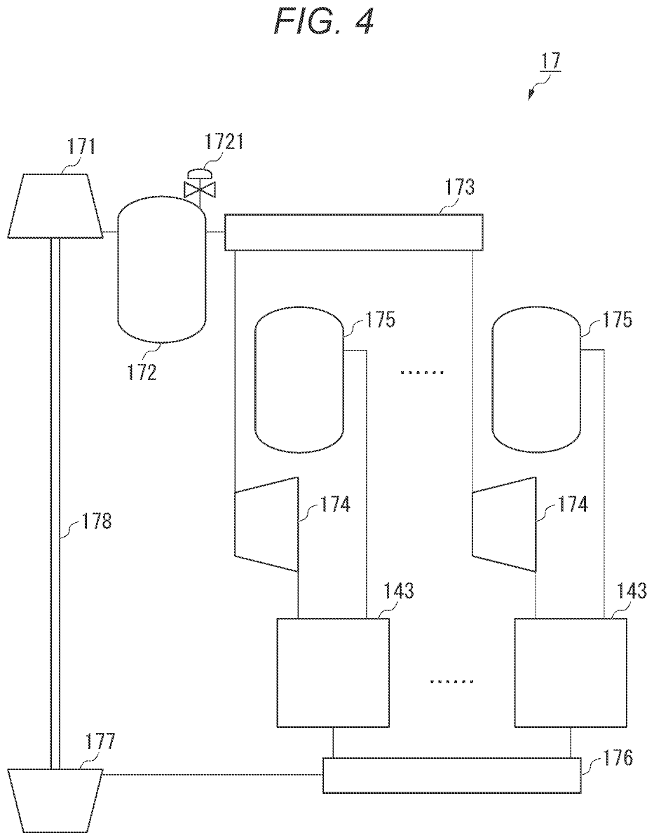

FIG. 4 is a schematic block diagram illustrating a configuration of a fuel cell system 17 according to a second embodiment. The fuel cell system 17 according to the second embodiment further includes an exhaust manifold 176, a turbine 177, and a shaft 178 in addition to the configuration of the first embodiment.

The exhaust manifold 176 includes a plurality of intake ports and one discharge port, and collects air supplied to each of the plurality of intake ports and discharges the air from the one discharge port. The number of intake ports of the exhaust manifold 176 is equal to the number of fuel cells 143. The intake port of the exhaust manifold 176 is connected to the discharge port of the corresponding fuel cell 143.

The turbine 177 rotates by receiving exhaust gas from the fuel cell 143. An intake port of the turbine 177 is connected to a discharge port of the exhaust manifold 176.

The shaft 178 connects the axis of rotation of the turbine 177 and the axis of rotation of the common air compressor 171 to match. The shaft 178 transfers the rotational energy of the turbine 177 to the common air compressor 171. That is, the common air compressor 171, the turbine 177, and the shaft 178 constitute a turbocharger.

### Operation and Effect

As described above, the fuel cell system 17 according to the second embodiment includes the turbine 177 that rotates by the exhaust gas discharged from the plurality of fuel cells 143 and drives the common air compressor 171 using the energy generated by the rotation. When the power generation current of the fuel cell 143 increases, the required air amount of the fuel cell 143 increases, and the operation rate of the common air compressor 171 increases. On the other hand, since the turbine 177 assists the rotation of the common air compressor 171, the fuel cell system 17 can suppress an increase in power consumption accompanying an increase in the power generation current of the fuel cell 143. In other embodiments, the common air compressor 171 and the turbine 177 may not constitute a turbocharger. For example, the fuel cell system 17 according to another embodiment may include a generator that generates power by rotation of the turbine 177, and the common air compressor 171 may be driven by the power of the generator.

### Other Embodiments

Although the embodiments have been described in detail with reference to the drawings, the specific configuration is not limited to the above-described configuration, and various design changes and the like can be made.

For example, in the above-described embodiments, the fuel cell system 17 is mounted on the transportation vehicle 10, but the present invention is not limited thereto. For example, in another embodiment, the fuel cell system 17 may be mounted on another work machine such as an excavator or a wheel loader.

According to the above aspect, a fuel cell system can prevent a change in responsiveness due to external atmospheric pressure.

1. A fuel cell system comprising:
a plurality of fuel cells that generate electric energy by reacting hydrogen gas with oxygen in air;
a plurality of individual air compressors provided respectively in the plurality of fuel cells, each of the individual air compressors boosting air to a desired operation pressure and supplying the air to a corresponding one of the fuel cells; and
a common air compressor provided on an upstream side of the plurality of individual air compressors, the common air compressor boosting air and supplying air having a predetermined reference pressure to the plurality of individual air compressors.

2. The fuel cell system according to claim 1, further comprising:
an air tank that
is provided downstream of the common air compressor and upstream of the plurality of individual air compressors,
stores air supplied by the common air compressor, and
supplies the air that has been stored to the plurality of individual air compressors at the reference pressure.

3. The fuel cell system according to claim 1, further comprising:
a turbine that rotates by exhaust gas discharged from the plurality of fuel cells and drives the common air compressor using energy generated by rotation.

4. A work machine including the fuel cell system according to claim 1, the work machine further comprising:
a work unit that is driven by electric energy generated by the plurality of fuel cells of the fuel cell system.
